(19) United States
(12) Patent Application Publication
(10) Pub. No.: US 2010/0271972 A1
(43) Pub. Date: Oct. 28, 2010

(54) COMMUNICATION DEVICE AND COMMUNICATION SYSTEM

(75) Inventors: Takayuki Fujii, Osaka (JP); Masaaki Tamai, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/810,238

(22) PCT Filed: Dec. 24, 2008
(86) PCT No.: PCT/JP2008/003914

§ 371 Date: Jun. 23, 2010

(30) Foreign Application Priority Data
Dec. 28, 2007 (JP) 2007-339794

(51) Int. Cl. H04B 17/00; H04L 27/00; H04L 12/26

(52) U.S. Cl. 370/252; 375/259; 375/228

(57) ABSTRACT

A communication device of the present invention is a communication device which performs data communication via a power line (3) whose transmission characteristics fluctuate, and includes: a parameter group setting unit (111) which sets a first group of transmission parameters; a degree-of-limitation determining unit (40) which determines a degree of limitation on group of transmission parameters for limiting a part of the first group of the transmission parameters; a parameter group converting unit (20) which converts, into a second group of transmission parameters, the first group of the transmission parameters, by limiting the part of the first group of the transmission parameters; a channel communicating unit (30) which obtains a result of transmission parameter evaluation data using the second group of the transmission parameters; and a parameter determining unit (111) which determines an optimal transmission parameter for current data communication, based on the result of the transmission parameter evaluation data.

### TECHNICAL FIELD

The present invention relates to communication devices and communication systems which perform data communication, and particularly to channel adaptation of a communication device at a time when transmission channel characteristics fluctuate.

### BACKGROUND ART

In a transmission system including transmission channels in which fluctuation occurs, in the case where no additions and modifications are made to ordinary transmitting units, there is a possibility of such severe frame loss that data transmission is disabled.

In such a transmission system, it is necessary to adjust, based on a signal received from a transmission medium, a transmission signal itself in compliant with a channel state at a time of the reception. As a unit achieving the above, there is a signal adjusting unit included in a communication device so that a transmission rate is maximized in the channel state.

Examples of conventional signal adjusting units include an equalizer which equalizes a transfer function of the transmission medium. The equalizer is required, for example, in the case where an error frequently occurs in a receiving device mainly due to a CNR (carrier to noise ratio) of the received signal. There is a possibility that the error occurs due to every noise source which can be present on the transmission channels in the transmission system or various noise sources such as an electronic external noise source which can interfere with inside the transmission channel in the transmission system.

In order to minimize an error rate of transmission information in the above-mentioned transmission system, the equalizer is required as the signal adjusting unit. Further, in order to achieve optimum waveform equalization, equalization characteristics need adjusting between each of terminals, because transmission channel characteristics between each of communication devices differ from each other due to a difference in length of a transmission line between each of the communication devices or a difference in transmission and reception characteristics.

Conventionally, for instance, the following is a waveform equalization method which performs channel adaptation on transmission channel characteristics of a network in which data communication is performed between communication devices mutually connected to a transmission channel. First, a partner terminal for data communication is identified based on a terminal identification signal attached to a start of a transmission block. Next, known test pattern data to be transmitted from the partner terminal is received, and equalization characteristics are adjusted so that the test pattern data can be received at a transmission rate maximized as much as possible. Then, the equalization characteristics optimized by the adjustment is stored, equalization characteristics matching the identified partner terminal is set to a waveform equalizer, and thus the data communication is performed.

### Patent Reference 1: Japanese Unexamined Patent Application Publication No. 2002-525917

### Patent Reference 2: Japanese Unexamined Patent Application Publication No. 2003-101444

### Patent Reference 3: Japanese Unexamined Patent Application Publication No. 2004-506376

### Patent Reference 4: Japanese Unexamined Patent Application Publication No. 2005-253076

### DISCLOSURE OF INVENTION

### Problems that the Invention is to Solve

However, although the above convention channel adaptation method is effective in the data communication through which data is transmitted and received at a transmission rate close to the maximum rate, there is a lower need for the method, for example, in communication where transfer of necessary information is completed and only polling data is transferred or communication where only a relatively small amount of data is transferred. In such a case, performing the data communication using the channel adaptation method which reduces the transmission error rate as much as possible rather than maximizes the transmission rate becomes important.

For instance, in an application in which latency limitation requiring real-time performance such as audio data communication and image data communication concerning a video is strict, a decrease in the transmission error rate is an important issue. For example, comparing a time required for retransmission processing in the case where data transfer is unsuccessful by one transmission due to a transmission error and a time required in the case where a transmission rate is significantly reduced instead of reducing a transmission error rate as much as possible shows that an overwhelmingly large amount of time is generally spent in the former case. However, in the latter case, successively performing the channel adaptation in an attempt to specifically reduce the transmission error rate makes it possible to reduce the error rate but increases the number of performances of the channel adaptation. Thus, there is a problem that power consumption is increased accordingly as a load of detecting processing for channel adaptation characteristics at a time of communication are increased concurrently with performing the channel adaptation itself which makes channel bands unavailable.

In view of the above problem, an object of the present invention is to provide a communication device and a communication system which reduce a processing time and a processing load required for channel adaptation processing performed for optimizing data communication with respect to a transmission channel in which fluctuation occurs.

### Means to Solve the Problems

In order to achieve the above object, a communication device according to the present invention is a communication device which performs data communication via a transmission channel whose transmission characteristics fluctuate, and includes: a parameter group setting unit which sets at least one first group of transmission parameters which defines a transmission condition of data; a degree-of-limitation determining unit which determines a degree of limitation on group of transmission parameters for limiting a part of the first group of the transmission parameters; a parameter group converting unit which converts, into a second group of transmission parameters, the first group of the transmission parameters set by the parameter group setting unit, by limiting the part of the first group of the transmission parameters according to the degree of limitation on group of transmission parameters; a channel communicating unit which transmits, to a partner communication device, transmission parameter evaluation data for evaluating the second group of the transmission parameters obtained through the conversion performed by the parameter group converting unit, using the second group of the transmission parameters, and to obtain a result of the transmission parameter evaluation data received from the partner communication device; and a parameter determining unit which determines an optimal transmission parameter for current data communication, based on the result of the transmission parameter evaluation data outputted from the channel communicating unit.

In the case where channel characteristics of a transmission channel that is a transmission medium fluctuate, optimization of transmission condition, that is, channel adaptation processing, is performed before data is transmitted to a partner communication device to be communicated with. In other words, a transmission parameter that is an optimal transmission condition is determined by communicating evaluation data with the partner communication device using a preset group of transmission parameters.

With the present invention, a type or an amount of a group of transmission parameters to be transmitted to the partner communication device is limited before the evaluation data is communicated with the partner communication device. Thus, it is possible to achieve time reduction in communication processing with the partner communication device required for the channel adaptation processing and load reduction in processing, and evaluation time reduction in determining the optimal transmission parameter based on data obtained through the communication processing and evaluation load reduction.

Furthermore, it is preferable that the channel communicating unit includes a result notifying unit configured to notify, to the degree-of-limitation determining unit, statistical information of the result of the transmission parameter evaluation data, and that the degree-of-limitation determining unit includes a recording unit on which a degree of limitation on group of transmission parameters used for past data communication and the statistical information notified by the result notifying unit are recorded as history information, and is configured to determine, based on the history information, a degree of limitation on group of transmission parameters necessary for the current data communication.

With this, highly accurate channel adaptation processing based on past processing results is performed, because a degree of limitation on group of transmission parameters is determined, based on a previously-used degree of limitation on group of transmission parameters or an evaluation result of evaluation data, when the second group of the transmission parameters is generated by limiting the first group of the transmission parameters.

Moreover, the communication device may further include a history communicating unit which notifies, to the recording unit, history information of an other communication device which is obtained by communicating with the other communication device, wherein the degree-of-limitation determining unit may determine the degree of limitation on group of transmission parameters necessary for the current data communication, based on history information including the history information notified from the history communicating unit.

With this, the degree of limitation on group of transmission parameters is determined, based not only on a previously-used degree of limitation on group of transmission parameters regarding a communication device itself and an evaluation result of evaluation data but also on a degree of limitation on group of transmission parameters regarding an other communication device and an evaluation result of evaluation data. Thus, the highly accurate channel adaptation processing based on the past processing results is performed, and at the same time channel adaptation processing having high adaptability for fluctuation of a communication system is performed.

Furthermore, the statistical information preferably includes at least one of a PHY (physical layer protocol) rate, a CNR (carrier to noise ratio), a decoding error rate, a MAC (medium access control) rate, a frame retransmission rate, a latency, and a packet loss rate.

With this, it is possible to achieve not only channel adaptation processing for maximizing a transmission rate but also channel adaptation processing most suitable for data communication according to conditions of various applications.

Moreover, the degree-of-limitation determining unit may include a training unit which performs a training sequence for determining a best degree of limitation on group of transmission parameters from among predetermined degrees of limitation on group of transmission parameters, by comparing in order the predetermined degrees of limitation on group of transmission parameters to the history information.

With this, when the second group of the transmission parameters is generated by limiting the first group of the transmission parameters is generated, the degree of limitation on group of transmission parameters set by the parameter group setting unit is evaluated by being compared to the previously-used degree of limitation on group of transmission parameters or the evaluation result of the evaluation data. Thus, more highly accurate channel adaptation processing in consideration of previous history information and a state of a current transmission channel is performed.

Furthermore, the training unit may regularly perform the training sequence.

With this, more highly accurate channel adaptation processing in consideration of updated history information and the state of the current transmission channel is performed.

Moreover, the channel communicating unit may include a classifying unit which classifies upper layer protocols of a data link layer, and the degree-of-limitation determining unit may determine a degree of limitation on group of transmission parameters necessary for current data communication based on the upper layer protocols classified by the classifying unit.

With this, it is possible to limit a group of transmission parameters with a greater degree of limitation because a data structure and the like can be determined based on the upper layer protocols, and thus further time and load reduction in the channel adaptation processing is achieved.

Furthermore, the degree-of-limitation determining unit may determine, from among preset fixed patterns, a degree of limitation on group of transmission parameters necessary for current data communication.

With this, a determination process for a degree of limitation on group of transmission parameters in the degree-of-limitation determining unit is simplified, and thus time reduction or load reduction in the entire channel adaptation processing is achieved depending on a state of the data communication.

Moreover, the degree-of-limitation determining unit may include a frequency dividing unit which performs frequency division on the first group of the transmission parameters in units, and may determine, for each of the units resulting from the performed frequency division, a degree of limitation on group of transmission parameters necessary for current data communication.

Further, it is preferable that the unit is a subcarrier which is a constituent unit of a carrier.

With this, the optimal transmission parameter is determined according to a modulation frequency or a bandwidth used in the data communication, and thus the highly accurate channel adaptation processing is performed.

Moreover, the degree of limitation on group of transmission parameters may include an upper limit for the number of transmission bits of the subcarrier.

With this, in the case of data communication in which reduction in a transmission error rate is focused, the time reduction or the load reduction in the channel adaptation processing is achieved.

Furthermore, the degree of limitation on group of transmission parameters may include a lower limit for the number of transmission bits of the subcarrier.

With this, in the case of data communication in which maximization of a transmission rate is focused, the time reduction or the load reduction in the channel adaptation processing is achieved.

Moreover, the degree-of-limitation determining unit may include a time dividing unit which performs time division on the first group of the transmission parameters in units, and may determine, for each of the units resulting from the performed time division, a degree of limitation on group of transmission parameters necessary for current data communication.

With this, the optimal transmission parameter is determined according to a case where data communication is performed for each delay time or the like, and thus the highly accurate channel adaptation processing is performed.

Moreover, the communication device may further include a channel characteristics information communicating unit which communicates control information regarding a channel characteristics fluctuating apparatus which causes the channel characteristics to fluctuate, and notifies the control information to the degree-of-limitation determining unit, wherein the degree-of-limitation determining unit may determine a degree of limitation on group of transmission parameters necessary for current data communication based on the control information.

For instance, the control information may be a noise profile of the channel characteristics fluctuating apparatus.

Alternatively, the control information may be the degree of limitation on group of transmission parameters according to a noise profile of the channel characteristics fluctuating apparatus.

Still alternatively, the control information may be chronological information of a noise profile of the channel characteristics fluctuating apparatus.

With this, when the second group of the transmission parameters is generated by limiting the first group of the transmission parameters, the degree of limitation on group of transmission parameters based not only on the previously-used degree of limitation on group of transmission parameters regarding the communication device and the evaluation result of the evaluation data but also on the control information regarding the other device having a factor affecting a transmission channel such as power source noise. Consequently, channel adaptation processing having high adaptability for fluctuation of a communication system is performed.

Furthermore, the channel communicating unit may include the channel characteristics information communicating unit.

With this, the channel communicating unit centrally manages communication with other communication devices, and thus simplification of a system regarding the channel adaptation processing is achieved.

Moreover, the control information may be an external direct input not via a communication medium.

With this, an acquisition unit acquires information to be a criterion for determining a degree of limitation on group of transmission parameters without the transmission channel, channel band reduction is avoided.

Furthermore, the channel characteristics fluctuating apparatus may be an electrical product.

With this, realized is network connection which enables an electrical product in which a state of power consumption sharply fluctuates such as a refrigerator and a computer to perform data communication based on the highly accurate channel adaptation processing.

Moreover, the degree-of-limitation determining unit may include a synthesizing unit which synthesizes N degrees of limitation on group of transmission parameters which are determined by a determining factor of M degrees of limitation on group of transmission parameters, where N is an integer equal to or greater than 2, M is an integer equal to or greater than 2, and M>N, and the parameter group converting unit may generate the second group of the transmission parameters by limiting the part of the first group of the transmission parameters, according to the degree of limitation on group of transmission parameters synthesized by the synthesizing unit.

With this, the synthesis limits a type or an amount of a group of transmission parameters to be transmitted to the partner communication device before the evaluation data is communicated with the partner communication device. Thus, it is possible to achieve the time reduction in communication processing with the partner communication device required for the channel adaptation processing and the load reduction in processing, and the evaluation time reduction in determining the optimal transmission parameter based on data obtained through the communication processing and the evaluation load reduction.

Furthermore, each of the first group of the transmission parameters and the second group of the transmission parameters may include at least one tone map.

With this, it is possible to determine a transmission parameter including a modulation method and an error-correction coding method.

Moreover, the transmission channel may be a power line.

With this, in a power line communication system in which large power source noise or sharp load fluctuation occurs, contribution to the system brought by the time reduction or the load reduction in the channel adaptation processing is very significant.

The present invention can be realized as the communication device having the above features, and the present invention realized as a communication system including such a communication device and a transmission channel provides the same structure and the same advantageous effects.

Furthermore, the present invention can be realized not only as the communication device including the above characteristic units and the communication system, but also as a communication method of a communication device in which the characteristic units included in the communication device are steps.

Moreover, the present invention can be realized not only as the communication method of a communication device including the characteristic steps, but also as a program causing a computer to execute the characteristic steps included in the communication method. Needless to say, such a program can be distributed via recording media such as a CD-ROM (Compact Disc Read Only Memory) or communication networks such as the Internet.

### EFFECTS OF THE INVENTION

A communication device and a communication system according to the present invention limits a group of transmission parameters to be evaluated, in channel adaptation processing for a transmission channel which fluctuates, before an optimal transmission parameter is determined by evaluating a group of transmission parameters specifying a transmission condition of data, and thus reduces a channel adaptation processing time and a channel adaptation processing load.

### BRIEF DESCRIPTION OF DRAWINGS

FIG. 1 is a functional block diagram of a communication system according to Embodiment 1 of the present invention.

FIG. 2 is a functional block diagram of a communication device according to Embodiment 1 of the present invention.

FIG. 3 (a), (b), and (c) is a diagram showing an example of generating a second tone map without conversion of a first tone map being performed by a parameter converting unit.

FIG. 4 is a flowchart of a training sequence in a degree-of-limitation determining unit.

FIG. 5 (a), (b), and (c) is a diagram showing parameter conversion in the case where history information is (34, 8, 5).

FIG. 6 is a diagram showing one example of history information stored in a storing unit at a time when a training sequence is completed.

FIG. 7 is a functional block diagram of a communication system according to Embodiment 2 of the present invention.

FIG. 8 is a functional block diagram of a communication device according to Embodiment 2 of the present invention.

FIG. 9 is one example of a header structure diagram of PDU.

FIG. 10 is a diagram showing a noise profile in a communication system.

FIG. 11 is a diagram showing a degree of limitation on group of optimized transmission parameters.

### NUMERICAL REFERENCES

1, 2, 4, 5 Communication device
3 Power line
6 Refrigerator
10 Channel setting unit
20 Parameter group converting unit
30, 50 Channel communicating unit
40, 60 Degree-of-limitation determining unit
111 Parameter determining unit
112 Parameter group setting unit
131, 151 Transmitting unit
132, 152 Result notifying unit
141, 161 Recording unit
142 Training unit
143, 163 Synthesizing unit
144, 164 Dividing unit
144A, 164A Frequency dividing unit
144B, 164B Time dividing unit
153 History communicating unit
154 Channel characteristics information communicating unit
155 Classifying unit

### BEST MODE FOR CARRYING OUT THE INVENTION

### Embodiment 1

When performing data communication via a transmission channel whose transmission characteristics fluctuate, a communication device according to Embodiment 1 limits a preset first group of transmission parameters according to a degree of limitation on group of transmission parameters, and converts the first group of the transmission parameters into a second group of transmission parameters. This limits a type or an amount of a group of transmission parameters to be transmitted to a partner communication device before channel adaptation processing for determining an optimal transmission parameter is performed. Thus, it is possible to achieve time reduction in communication processing with the partner communication device required for the channel adaptation processing and load reduction in processing, and evaluation time reduction in determining the optimal transmission parameter based on data obtained through the communication processing and evaluation load reduction.

The following describes in detail Embodiment 1 of the present invention with reference to the drawings.

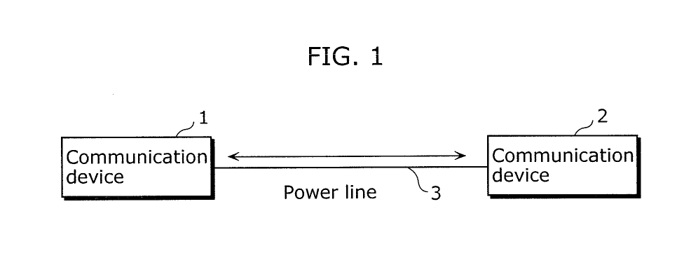

FIG. 1 is a functional block diagram of a communication system according to Embodiment 1 of the present invention. The communication system in the figure includes a communication device 1, a communication device 2, and a power line 3.

The communication devices 1 and 2 are connected to the power line 3, and communicate data with each other via the power line 3.

The power line 3 functions as a transmission channel which transmits data.

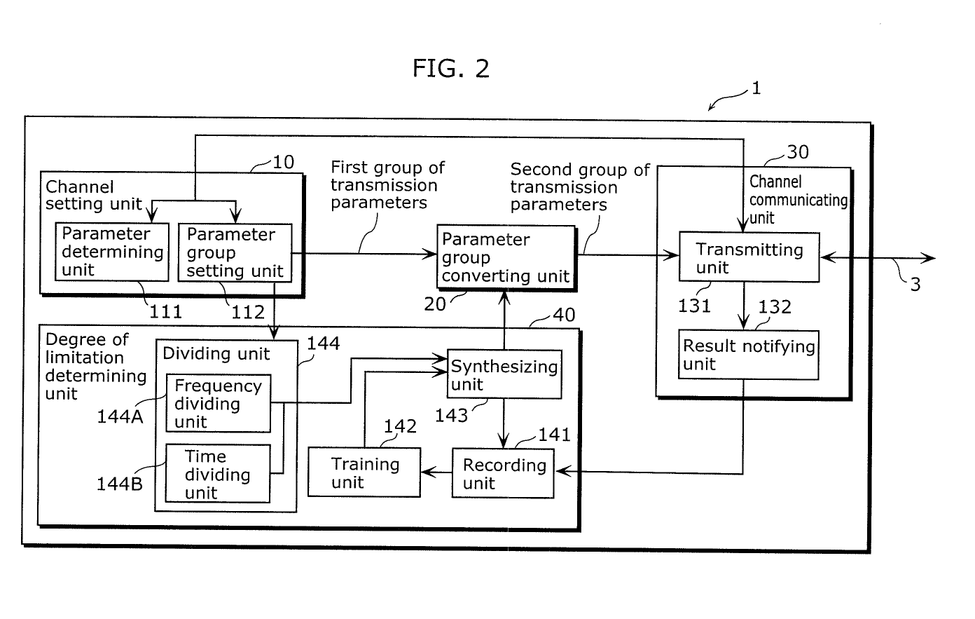

FIG. 2 is a functional block diagram of the communication device 1 according to Embodiment 1 of the present invention. The communication device 1 in the figure includes a channel setting unit 10, a parameter group converting unit 20, a channel communicating unit 30, and a degree-of-limitation determining unit 40.

The channel setting unit 10 includes a parameter determining unit 111 and a parameter group setting unit 112. The channel setting unit 10 performs conventional channel adaptation for internal processing, that is, determines an optimal transmission parameter from a predetermined group of transmission parameters. The parameter group setting unit 112 generates a first group of transmission parameters based on characteristics of the power line 3, and outputs the first group of the transmission parameters to the parameter group converting unit 20. The parameter determining unit 111 obtains, from the channel communicating unit 30, an evaluation result of a second group of transmission parameters to determine the optimal transmission parameter.

When receiving the first group of the transmission parameters, the parameter group converting unit 20 performs conversion according to a degree of limitation on group of transmission parameters specified by the degree-of-limitation determining unit 40 to generate the second group of the transmission parameters, and outputs the second group of the transmission parameters to the channel communicating unit 30.

The channel communicating unit 30 includes a transmitting unit 131 and a result notifying unit 132. When receiving the second group of the transmission parameters, the transmitting unit 131 transmits evaluation data to the power line 3 according to the second group of the transmission parameters. The result notifying unit 132 outputs, to the degree-of-limitation determining unit 40, statistical information of a transmission result obtained through the transmission of the evaluation data.

The degree-of-limitation determining unit 40 includes a recording unit 141, a training unit 142, a synthesizing unit 143, and a dividing unit 144. The recording unit 141 records the transmission result of the evaluation data received from the channel communicating unit 30 and the determined degree of limitation on group of transmission parameters, and also outputs, to the training unit 142, the transmission result and the degree of limitation on group of transmission parameters. Here, the degree of limitation on group of transmission parameters is a degree to which the first group of the transmission parameters is limited to the second group of the transmission parameters. The training unit 142 outputs, to the synthesizing unit 143, a degree of limitation on group of transmission parameters obtained as a result of comparing the received transmission result of the evaluation data and a current degree of limitation on group of transmission parameters. The synthesizing unit 143 synthesizes the first group of the transmission parameters analyzed by the dividing unit 144 and the degree of limitation on group of transmission parameters, and outputs the synthesis result to the parameter group converting unit 20 and the recording unit 141. The dividing unit 144 divides a transmission parameter, and includes a frequency dividing unit 144A and a time dividing unit 144B. The frequency dividing unit 144A divides the transmission parameter on a frequency basis, and the time dividing unit 144B divides the transmission parameter on a time basis.

Here, the group of the transmission parameters is, for example, a tone map, and the following describes in more detail Embodiment 1 of the present invention with the group of the transmission parameters being the tone map.

The tone map is the group of the transmission parameters as stated above, and is a set of transmission parameters each of which is set for a corresponding one of subcarriers. A subcarrier is a minimum constituent unit of a carrier. A transmission parameter is a degree of modulation of each subcarrier. The degree of modulation is the number of transmission bits or strength of error-correction code of a corresponding subcarrier. Here, for the brevity of the description, the degree of limitation on group of transmission parameters is a conversion method which limits the number of transmission bits for the whole set of the subcarriers of the tone map. As a method of limiting the number of transmission bits, for instance, the limitation is performed by setting an upper limit common to all the subcarriers, and control or the limitation of the number of transmission bits is performed in a range of 1 to 10 bits and on a 1-bit basis.

Here, the above-mentioned determination of the upper limit for the number of transmission bits of the tone map is described through a training sequence mainly performed by the training unit 142 in the degree-of-limitation determining unit 40.

First, in an initial state of training, there is no information to be stored in the recording unit 141 because there is no notification from the result notifying unit 132, and there is also no information to be outputted from the recording unit 141 to the training unit 142. Consequently, the training unit 142 notifies the synthesizing unit 143 to set a state where no conversion is performed, that is, a state where the limitation on the number of transmission bits for the set of subcarriers is not performed. The synthesizing unit 143 outputs, to the parameter group converting unit 20, a conversion method which does not perform the limitation.

Next, the parameter group converting unit 20 outputs, to the channel communicating unit 30, a first tone map received from the channel setting unit 10, as a second tone map, without performing conversion on the first tone map.

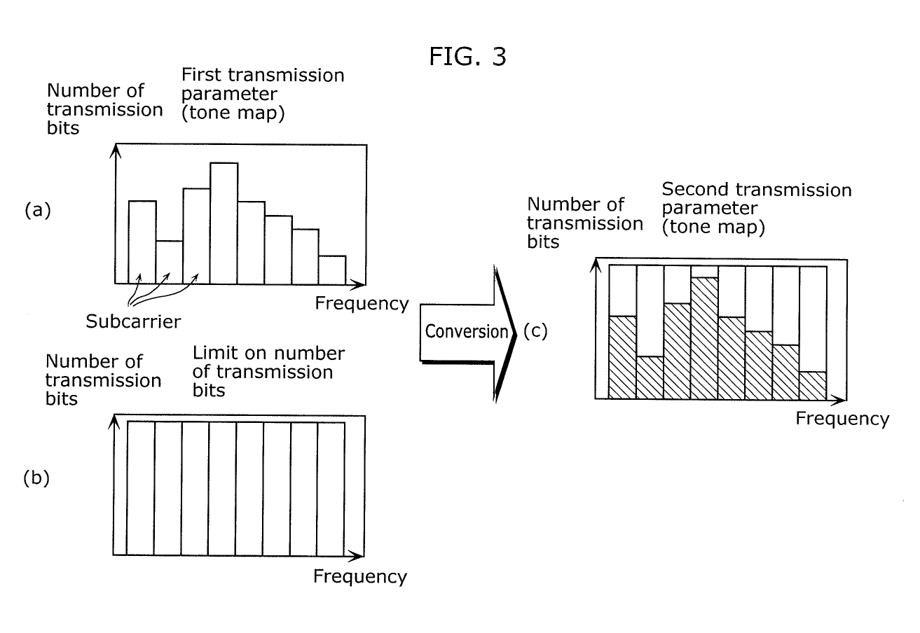

FIG. 3 is a diagram showing an example where the parameter group converting unit 20 generates the second tone map without performing the conversion on the first tone map. In the figure, bar graphs show the number of transmission bits for each subcarrier that is a unit of frequency. FIG. 3 (a) shows a first tone map. FIG. 3 (b) shows a tone map in which there is no limitation on the number of transmission bits for each subcarrier, that is, in which the limitation on the number of transmission bits is represented by the maximum number of transmission bits. In FIG. 3 (c) which shows a conversion result, a second tone map is generated without changing the number of transmission bits for whole frequencies.

Next, the transmitting unit 131 transmits evaluation data according to the received second tone map, and outputs statistical information of the transmission result to the recording unit 141 via the result notifying unit 132.

Next, the recording unit 141 records, as history information, a pair of the statistical information of the transmission result received from the result notifying unit 132 and the conversion method received from the synthesizing unit 143, and transmits the history information to the training unit 142.

Next, the training unit 142 compares the best history information as history information as training to current history information, and keeps whichever shows a more optimal result.

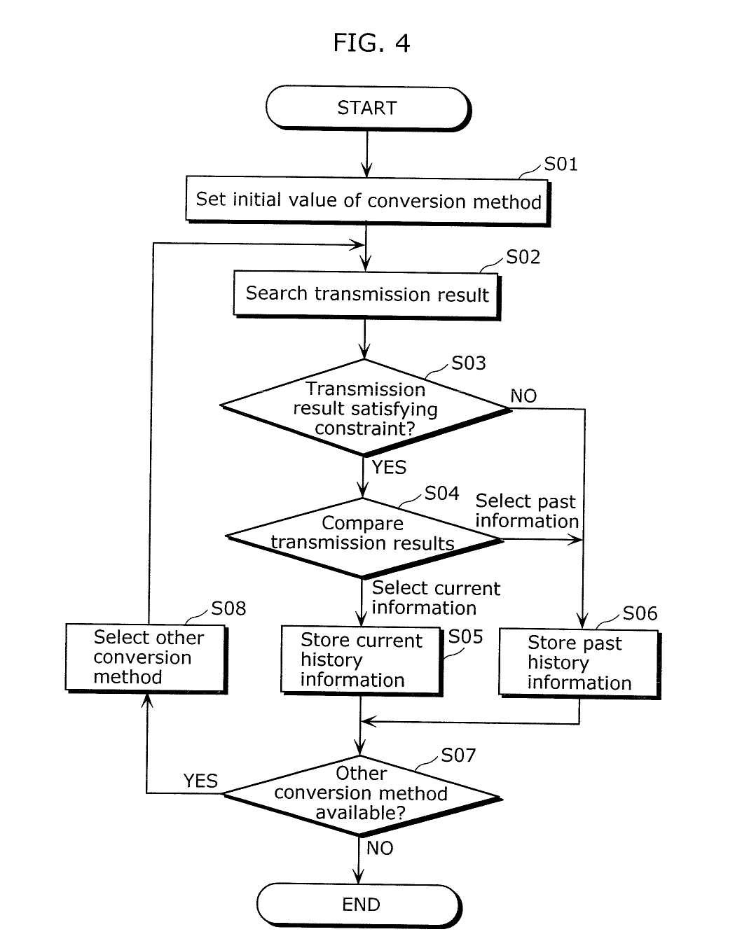

FIG. 4 is a flowchart of a training sequence in the degree-of-limitation determining unit 40. Here, the following description is made assuming that the statistical information of the transmission result of the evaluation data (hereinafter, for simplicity, referred to as transmission result) is a MAC (Media Access Control) rate and a latency. Further, as evaluation priority of each of transmission results, the MAC rate is given the top priority, and the latency is given the second priority.

First, as described in FIG. 3(c), the training unit 142 sets a state where there is no limitation on the number of transmission bits to be an initial value in the initial state of the training sequence (S01).

Next, the training unit 142 obtains a transmission result corresponding to the initial value (S02). History information is represented by (MAC rate (Mbps), latency (millisecond), upper limit for the number of transmission bits (bit)). Here, it is assumed that (50, 5, 10) is obtained as a transmission result of this time. In FIG. 2, the transmitting unit 131 obtains a MAC rate and a latency, and transfers a transmission result to the recording unit 141 via the result notifying unit 132. The synthesizing unit 143 synthesizes the transmission result with the previous statistical information by transferring the upper limit for the number of transmission bits to the recording unit 141, so as to obtain one history information item, and transfers the history information item to the training unit 142.

Next, although the training unit 142 determines whether or not the obtained transmission result satisfies constraints, the training unit 142 determines that there is no constraint, that is, everything is YES (S03), because there is no constraint on transmission results in the present embodiment. It is to be noted that the determination at the present step S03 is explained in an embodiment to be described.

Next, the training unit 142 compares transmission results (S04). Current history information remains as it is, because there is no past history information as training in the initial state. In the case where the current information remains, the processing advances to a step S05, and the current information is stored as the best past history information (S05).

Next, when there is still a conversion method candidate that has not been performed among conversion method candidates that are training targets (YES in S07), the training unit 142 selects another conversion method (508). In the present embodiment, 10 bits (an upper limit for the number of transmission bits) which are an initial value are decreased 1-bit at a time.

Next, the training unit 142 sets limitation on the number of transmission bits to 9 bits (S08).

Next, the training unit 142 obtains a transmission result obtained with the limitation on the number of transmission bits being 9 bits (S02). Here, history information is (42, 6, 9).

Next, as there is no constraint in the step S03, the processing advances to the step S04.

Next, the training unit 142 compares past history information (42, 5, 10) and current history information (42, 6, 9) (S04). Here, for instance, in the present embodiment, the past history information is selected in conformity with the rule that latencies which are given the second priority are compared in the case where MAC rates which are given the top priority are the same (S06).

Next, when there is again still a conversion method candidate that has not been performed among the conversion method candidates that are the training targets (YES in S07), the training unit 142 selects still another conversion method (S08).

As stated above, the training unit 142 performs the above sequence until the upper limit for the number of transmission bits reaches 1 bit, and the training sequence is completed.

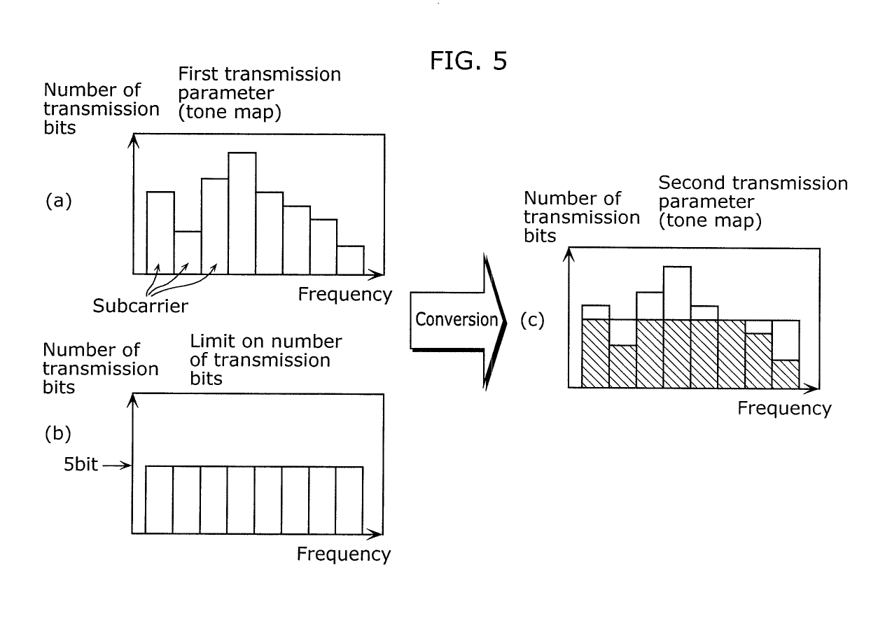

FIG. 5 is a diagram showing parameter conversion in the case where history information is (34, 8, 5). In the figure, bar graphs show the number of transmission bits for each subcarrier that is a unit of frequency. FIG. 5 (a) shows a first tone map. FIG. 5 (b) shows that an upper limit for the number of transmission bits, which is used by a conversion method, is 5 bits. In FIG. 5 (c) which shows a conversion result, a second tone map is generated in which an upper limit for the number of transmission bits marked with diagonal lines is applied to each subcarrier.

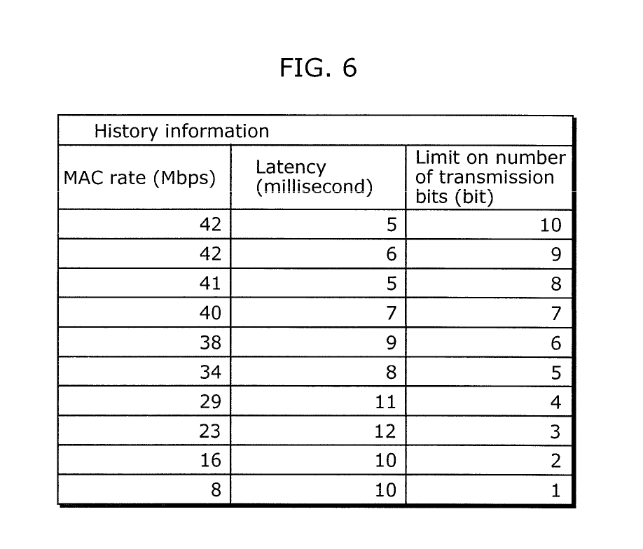

FIG. 6 is a diagram showing one example of history information stored in the storing unit 141 at a time when a training sequence is completed. In the case where a history information table as shown in the figure is obtained, history information stored as past information at the time when the training sequence is completed is (42, 5, 10) whose high-priority MAC rate of a transmission result is highest and whose latency is lowest among history information items in the case where there are the same MAC rates.

Accordingly, 10 bits (the upper limit for the number of transmission bits) are used by the conversion method that is the degree of limitation on group of transmission parameters until occurrence of a substantial transmission channel fluctuation requires training after the training sequence is completed. Thus, the first group of the transmission parameters is limited by 10 bits (the upper limit for the number of transmission bits) to generate the second group of the transmission parameters, and the data transmission is performed by the channel communicating unit 30.

The above training sequence may be performed at a time when the substantial transmission channel fluctuation occurs or may be performed regularly.

In the above embodiment, as the result of performing the training sequence, the conversion method which uses 10 bits as the upper limit for the number of transmission bits is employed as the conversion method which limits the first group of the transmission parameters to the second group of the transmission parameters. In response to the result, the channel setting unit 10 which performs the conventional channel adaptation processing performs optimization of each transmission parameter at a time when actual data communication is performed. For example, the channel setting unit 10 performs channel adaptation processing in which data communication is performed after an upper limit for the number of transmission bits is determined for each subcarrier by performing preliminary communication with a partner device before the data communication. Although the conversion method which uses 10 bits as the upper limit for the number of transmission bits as the result of performing the above training sequence is employed, it is assumed that as a result of performing the training sequence in another occasion, a conversion method which uses 7 bits as the upper limit for the number of transmission bits is employed as the conversion method which limits the first group of the transmission parameters to the second group of the transmission parameters. In this case, when an upper limit for the number of transmission bits is determined for each subcarrier during the channel adaptation processing performed by the channel setting unit 10, it is not necessary to perform preliminary communication of 10 to 7 bits (the upper limit for the number of transmission bits) for all the subcarriers. Accordingly, the type or the amount of the transmission parameter to be transmitted to the partner communication device is limited before the channel adaptation processing for determining the optimal transmission parameter is performed. Thus, it is possible to achieve the time reduction in communication processing with the partner communication device required for the channel adaptation processing and the load reduction in processing, and the evaluation time reduction in determining the optimal transmission parameter based on the data obtained through the communication processing and in the evaluation load reduction.

It is to be noted that although the power line 3 is the transmission channel in the present embodiment, the transmission channel may be a channel requiring channel adaptation. For example, the present invention is applied to a wireless network if the wireless network requires channel adaptation.

Furthermore, although the channel adaptation in the case where the data communication between the communication devices 1 and 2 is performed has been described in the present embodiment, the number of communication devices is not limited to two.

Moreover, the transmission parameter does not need to be only the tone map, and may be a bandwidth, a modulation method, an error-correcting system, and a multiplexing method, or a combination of these.

Furthermore, the conversion method which is the degree of limitation on group of transmission parameters does not need to be set by the upper limit for the number of transmission bits, and may be set by a lower limit or an average value. Moreover, the conversion method may be conversion of another parameter of the tone map, and may further be conversion of a transmission parameter.

Furthermore, instead of determining the conversion method which is one degree of limitation on group of transmission parameters, the synthesizing unit 143 may limit the conversion method to N (M>N) conversion methods obtained by synthesizing M conversion methods.

Moreover, the statistical information of the transmission result may be a PHY (physical layer protocol) rate, a CNR (carrier to noise ratio), a decoding error rate, a frame retransmission rate or a packet loss rate.

Furthermore, the history information may be the degree of limitation on group of transmission parameters or the statistical information of the transmission result, and may be a set of history information items including at least respective one of the above elements.

Moreover, the synthesizing unit 143 does not need to directly transfer the degree of limitation on group of transmission parameters to the recording unit 141, and may transfer the degree of limitation on group of transmission parameters via the transmitting unit 131.

### Embodiment 2

A communication device according to Embodiment 2 obtains noise information in advance when performing data communication via a transmission channel connected with a device having a noise source which causes transmission characteristics to substantially fluctuate, and thus limits a preset first group of transmission parameters according to a degree of limitation on group of transmission parameters and converts the first group of the transmission parameters into a second group of transmission parameters. This limits a type or an amount of a group of transmission parameters to be transmitted to a partner communication device before channel adaptation processing for determining an optimal transmission parameter is performed, so that channel adaptation processing highly adaptable to fluctuation of a communication system is performed.

The following describes in detail Embodiment 2 of the present invention with reference to the drawings.

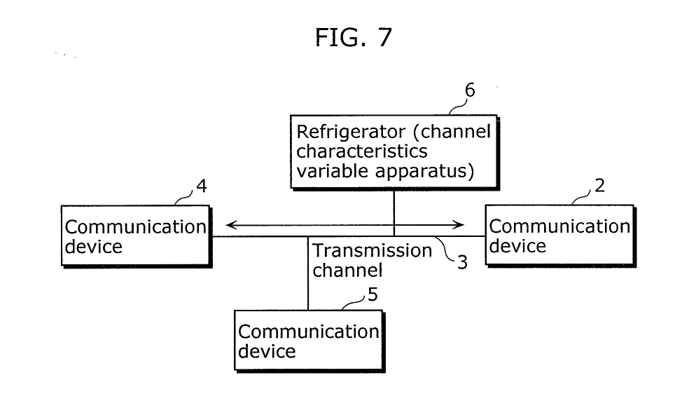

FIG. 7 is a functional block diagram of a communication system according to Embodiment 2 of the present invention. The communication system in the figure includes a communication device 2, a power line 3, communication devices 4 and 5, and a refrigerator 6.

The communication devices 2, 4 and 5 and the refrigerator 6 are connected to the power line 3, and communicate data with each other via the power line 3.

The power line 3 functions as a transmission channel which transmits data.

The refrigerator 6 includes the same communication device as the communication devices 2, 4, and 5, and also has a noise source which causes transmission channel characteristics of the power line 3 to fluctuate.

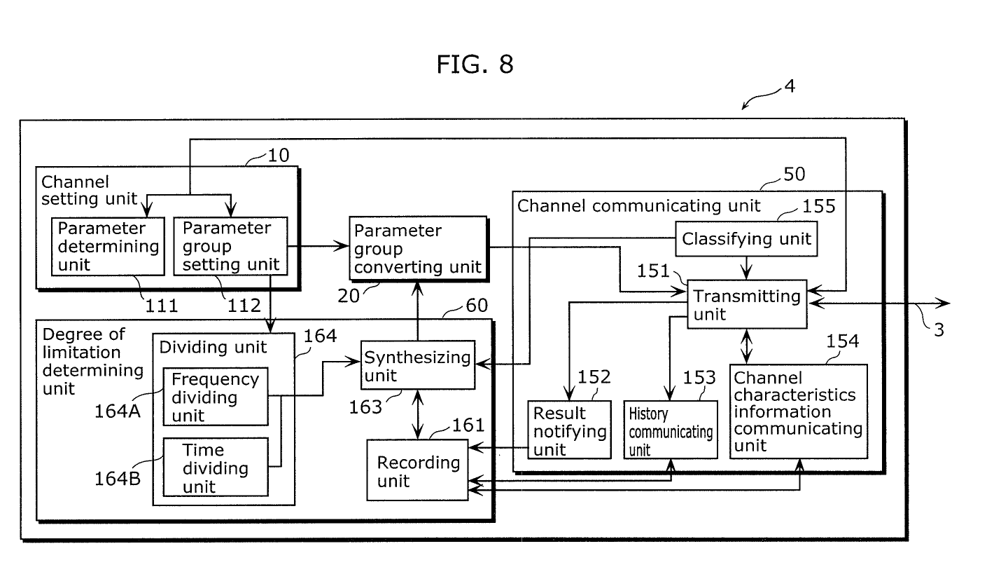

FIG. 8 is a functional block diagram of the communication device according to Embodiment 2 of the present invention. The communication device 4 in the figure includes a channel setting unit 10, a parameter group converting unit 20, a channel communicating unit 50, and a degree-of-limitation determining unit 60. In comparison to the communication device 2 according to Embodiment 1 shown in FIG. 2, the communication device 4 in the figure differs in functions of the channel communicating unit 50 and the degree-of-limitation determining unit 60. Hereinafter, the same points as in the communication device 2 shown in FIG. 2 are not described, and only differences from the communication device 2 are described.

The channel communicating unit 50 includes a transmitting unit 151, a result notifying unit 152, a history communicating unit 153, a channel characteristics information communicating unit 154, and a classifying unit 155.

When receiving a second group of transmission parameters, the transmitting unit 151 transmits evaluation data to the power line 3 according to the second group of the transmission parameters. In addition, the transmitting unit 151 outputs, to the result notifying unit 152, statistical information of a transmission result obtained through the transmission of the evaluation data, and exchanges information with the history communicating unit 153, the channel characteristics information communicating unit 154, and the classifying unit 155 that are to be described later.

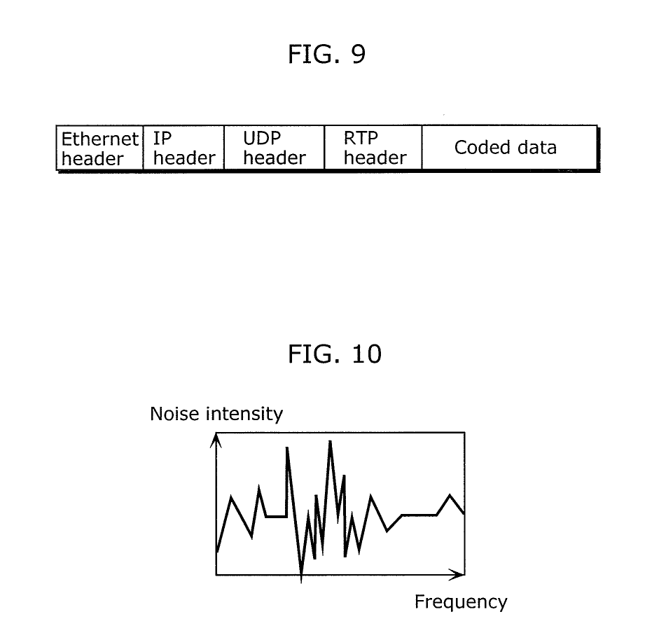

The classifying unit 155 determines transmission data based on a protocol higher than a data link layer. For example, the classifying unit 155 determines transmission data as a VoIP (Voice over Internet Protocol) when receiving a PDU (Protocol Data Unit) having a header structure shown in FIG. 9, and notifies classification information to the synthesizing unit 163. Accordingly, the synthesizing unit 163 having received the notification finds out a necessary MAC rate because the transmission data is a VoIP packet having a fixed length, and thus determines history information satisfying a necessary rate and having lowest latency as a conversion method that is a degree of limitation on group of transmission parameters.

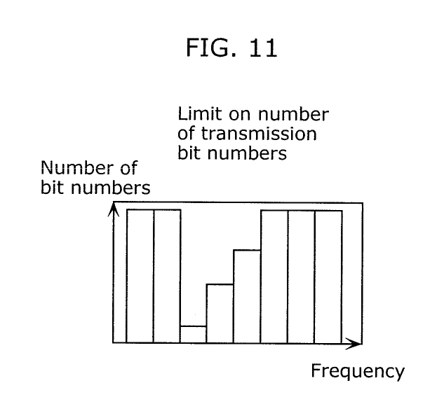

The history communicating unit 153 transfers, between the communication devices, database information accumulated as history information in the recording unit 161. This allows the history information between the communication devices to coexist, and is effective to a case where it is desired to apply the conversion method, which is the degree of limitation on group of transmission parameters, to noise information which has little dependence due to presence of communication device on the power line 3 and which is a characteristic common to transmission channels. For instance, in the case where noise shown in FIG. 10 is in a communication system, the conventional techniques cannot ensure communication until the channel adaptation is completed. On the other hand, in the case where the communication device 5, which is not a communication party unlike the communication device 5 in FIG. 7, has already completed the channel adaptation and the optimization of the conversion method as exemplified in FIG. 11, the conversion method can be used as history information of the communication device 4 by performing communication from the communication device 5 to the communication device 4 via the history communicating unit 153. Consequently, the communication device 4 can apply the conversion method shown in FIG. 11 before the channel adaptation and the optimization of the degree of limitation on group of transmission parameters are performed.

The channel characteristics information communicating unit 154 performs transfer of control information regarding operations of a channel fluctuating device which causes substantial channel fluctuation such as the refrigerator 6 in FIG. 7. Here, the description continues assuming that control information handled by the channel communicating unit 50 is, for example, operation information regarding an apparatus. When the refrigerator 6 starts, transmission channel characteristics are fluctuated by unique noise of the refrigerator 6 which has not been in a transmission channel but is generated by start of an electric motor and the like therein. In order to notify the above in advance, at the start time, it is necessary to communicate with the refrigerator 6 initially using the channel characteristics information communicating unit 154. As a result, it is possible to determine the fluctuation of the transmission channel characteristics beforehand. Concurrently, it is possible to search a database stored as history information for a conversion method according to the fluctuation of the transmission channel characteristics of the refrigerator 6, and apply the conversion method. Not only at the start time but also in the case where an operation whose operation mode varies significantly such as quick-freezing and change of selected room is started, there is a possibility that the fluctuation of the transmission channel characteristics occurs in the same manner. Even in such a case, the advance notification makes it possible to adapt to the fluctuation of the transmission channel characteristics beforehand.

It is to be noted that the history information from the communication device 5 or the refrigerator 6 in the above case is a noise profile itself or a degree of limitation on group of transmission parameters according to the noise profile. In addition, the noise profile may be frequency characteristics of the noise shown in FIG. 10 or chronological characteristics.

As described above, the communication device according to Embodiment 2 includes: the classifying unit which classifies upper layer protocols of a data link layer; the history communicating unit which obtains the history information of the other communication device obtained by communicating with the other communication device; and the channel characteristics information communicating unit which obtains the control information regarding the channel characteristics fluctuating apparatus which causes the channel characteristics to fluctuate. As a result, when the second group of the transmission parameters is generated by limiting the first group of the transmission parameters, determined are not only the previously-used conversion method regarding the communication device itself and the evaluation result of the evaluation data but also the conversion method regarding the other communication device and the evaluation data or the conversion method obtained through the structural analysis of the transmission data. Thus, highly accurate channel adaptation processing based on the past processing results is performed, and at the same time channel adaptation processing having high adaptability for the fluctuation of the communication system is performed.

It is to be noted that information which the classifying unit 155 notifies to the synthesizing unit 163 is not always necessarily the classification information, and may be a degree of limitation on group of transmission parameters based on the classification information.

Furthermore, information which the channel characteristics information communicating unit 154 communicates is not always necessarily operation information regarding an apparatus itself, and may be, for instance, a degree of limitation on group of transmission parameters which is effective to noise caused by the apparatus and a profile of the noise.

Moreover, the history communicating unit 153 and the channel characteristics information communicating unit 154 are not always necessarily included in the channel communicating unit 50, and may be an independent transmitting unit for which a communication medium such as radio transmission, infrared light, and laser, which is a channel different from the power line 3, is used.

Furthermore, the degree of limitation on group of transmission parameters is not determined by the degree-of-limitation determining unit upon information analysis using information or the like from the channel communicating unit, but may be determined from among preset fixed patterns.

It is to be noted that the communication device and the communication system according to the present invention are not limited to the above embodiments. The present invention includes other embodiments achieved by combining any components in Embodiments 1 and 2, modifications obtained by making, to Embodiments 1 and 2, various modifications conceived by those skilled in the art within the scope of the present invention, and various apparatuses including the communication device or the communication system according to the present invention. For example, in Embodiment 2, the training unit described in Embodiment 1 may be included in the degree-of-limitation determining unit 60.

### INDUSTRIAL APPLICABILITY

The present invention is useful for communication devices and communication systems which perform data communication, and is particularly most suitable for a communication system which performs the data communication via a power line.

1. A communication device which performs data communication via a transmission channel whose transmission characteristics fluctuate, said communication device comprising:
a parameter group setting unit configured to set at least one first group of transmission parameters which defines a transmission condition of data;
a degree-of-limitation determining unit configured to determine a degree of limitation on group of transmission parameters for limiting a part of the first group of the transmission parameters;
a parameter group converting unit configured to convert, into a second group of transmission parameters, the first group of the transmission parameters set by said parameter group setting unit, by limiting the part of the first group of the transmission parameters according to the degree of limitation on group of transmission parameters;
a channel communicating unit configured to transmit, to a partner communication device, transmission parameter evaluation data for evaluating the second group of the transmission parameters obtained through the conversion performed by said parameter group converting unit, using the second group of the transmission parameters, and to obtain a result of the transmission parameter evaluation data received from the partner communication device; and
a parameter determining unit configured to determine an optimal transmission parameter for current data communication, based on the result of the transmission parameter evaluation data outputted from said channel communicating unit.

2. The communication device according to claim 1,
wherein said channel communicating unit includes a result notifying unit configured to notify, to said degree-of-limitation determining unit, statistical information of the result of the transmission parameter evaluation data, and
said degree-of-limitation determining unit includes a recording unit on which a degree of limitation on group of transmission parameters used for past data communication and the statistical information notified by said result notifying unit are recorded as history information, and is configured to determine, based on the history information, a degree of limitation on group of transmission parameters necessary for the current data communication.

3. The communication device according to claim 2, further comprising
a history communicating unit configured to notify, to said recording unit, history information of an other communication device which is obtained by communicating with the other communication device,
wherein said degree-of-limitation determining unit is configured to determine the degree of limitation on group of transmission parameters necessary for the current data communication, based on history information including the history information notified from said history communicating unit.

4. The communication device according to claim 2,
wherein the statistical information includes at least one of a PHY (physical layer protocol) rate, a CNR (carrier to noise ratio), a decoding error rate, a MAC (medium access control) rate, a frame retransmission rate, a latency, and a packet loss rate.

5. The communication device according to claim 2,
wherein said degree-of-limitation determining unit includes a training unit configured to perform a training sequence for determining a best degree of limitation on group of transmission parameters from among predetermined degrees of limitation on group of transmission parameters, by comparing in order the predetermined degrees of limitation on group of transmission parameters to the history information.

6. The communication device according to claim 5,
wherein said training unit is configured to regularly perform the training sequence.

7. The communication device according to claim 1,
wherein said channel communicating unit includes a classifying unit configured to classify upper layer protocols of a data link layer, and
said degree-of-limitation determining unit is configured to determine a degree of limitation on group of transmission parameters necessary for current data communication based on the upper layer protocols classified by said classifying unit.

8. The communication device according to claim 1,
wherein said degree-of-limitation determining unit is configured to determine, from among preset fixed patterns, a degree of limitation on group of transmission parameters necessary for current data communication.

9. The communication device according to claim 1,
wherein said degree-of-limitation determining unit includes a frequency dividing unit configured to perform frequency division on the first group of the transmission parameters in units, and is configured to determine, for each of the units resulting from the performed frequency division, a degree of limitation on group of transmission parameters necessary for current data communication.

10. The communication device according to claim 9,
wherein the unit is a subcarrier which is a constituent unit of a carrier.

11. The communication device according to claim 10,
wherein the degree of limitation on group of transmission parameters includes an upper limit for the number of transmission bits of the subcarrier.

12. The communication device according to claim 10,
wherein the degree of limitation on group of transmission parameters includes a lower limit for the number of transmission bits of the subcarrier.

13. The communication device according to claim 1,
wherein said degree-of-limitation determining unit includes a time dividing unit configured to perform time division on the first group of the transmission parameters in units, and is configured to determine, for each of the units resulting from the performed time division, a degree of limitation on group of transmission parameters necessary for current data communication.

14. The communication device according to claim 1 further comprising,
a channel characteristics information communicating unit configured to communicate control information regarding a channel characteristics fluctuating apparatus which causes the channel characteristics to fluctuate, and notify the control information to said degree-of-limitation determining unit,
wherein said degree-of-limitation determining unit is configured to determine a degree of limitation on group of transmission parameters necessary for current data communication based on the control information.

15. The communication device according to claim 14,
wherein the control information is a noise profile of the channel characteristics fluctuating apparatus.

16. The communication device according to claim 14,
wherein the control information is the degree of limitation on group of transmission parameters according to a noise profile of the channel characteristics fluctuating apparatus.

17. The communication device according to claim 14,
wherein the control information is chronological information of a noise profile of the channel characteristics fluctuating apparatus.

18. The communication device according to claim 14,
wherein said channel communicating unit includes said channel characteristics information communicating unit.

19. The communication device according to claim 14,
wherein the control information is an external direct input not via a communication medium.

20. The communication device according to claim 14,
wherein the channel characteristics fluctuating apparatus is an electrical product.

21. The communication device according to claim 1,
wherein said degree-of-limitation determining unit includes a synthesizing unit configured to synthesize N degrees of limitation on group of transmission parameters which are determined by a determining factor of M degrees of limitation on group of transmission parameters, where N is an integer equal to or greater than 2, M is an integer equal to or greater than 2, and M>N, and
said parameter group converting unit is configured to generate the second group of the transmission parameters by limiting the part of the first group of the transmission parameters, according to the degree of limitation on group of transmission parameters synthesized by said synthesizing unit.

22. The communication device according to claim 1,
wherein each of the first group of the transmission parameters and the second group of the transmission parameters includes at least one tone map.

23. The communication device according to claim 1,
wherein the transmission channel is a power line.

24. A communication system comprising a transmission channel whose transmission characteristics fluctuate and the communication devices of claim 1 connected to said transmission channel.

25. A communication method used in a communication device which performs data communication via a transmission channel whose transmission characteristics fluctuate, said communication method comprising:
setting at least one first group of transmission parameters which defines a transmission condition of data for the transmission channel;
determining a degree of limitation on group of transmission parameters for limiting a part of the first group of the transmission parameters;
converting the first group of the transmission parameters into a second group of transmission parameters according to the degree of limitation on group of transmission parameters set in said setting; and
transmitting, to a partner communication device, transmission parameter evaluation data using the second group of the transmission parameters, and determining an optimal transmission parameter based on a result of the transmission parameter evaluation data received from the partner communication device.

26. A computer-executable program for a communication device which performs data communication via a transmission channel whose transmission characteristics fluctuate, said program causing a computer to execute the communication method of claim 25.
